(19) United States
(12) Patent Application Publication
(10) Pub. No.: US 2025/0385476 A1
(43) Pub. Date: Dec. 18, 2025

(54) ALIGNMENT DEVICE FOR WIRELESS COMMUNICATION IN ROTARY JOINT

(71) Applicant: DEUBLIN COMPANY, LLC, Waukegan, IL (US)

(72) Inventors: Matt JAKYMIW, Park Ridge, IL (US); Anton A. PETROU, Hawthorn Woods, IL (US); Lu HAN, Libertyville, IL (US)

(73) Assignee: DEUBLIN COMPANY, LLC, Waukegan, IL (US)

(21) Appl. No.: 19/239,216

(22) Filed: Jun. 16, 2025

Related U.S. Application Data
(60) Provisional application No. 63/660,870, filed on Jun. 17, 2024.

(51) Int. Cl. H01R 39/08; H01Q 3/02; H02J 50/10

(52) U.S. Cl. CPC H01R 39/08; H01Q 3/02; H02J 50/10

(57) ABSTRACT

A rotary joint, alignment module and wireless power transfer circuit for a rotary joint. The slip ring includes a stator; a rotor configured to rotate relative to the stator about a rotation axis; and an alignment module mounted to the rotor. The alignment module includes a housing having a first wireless module with a first antenna. The slip ring also includes a rotational element coupled to the first rotor and configured to rotate about the rotation axis relative to the housing, the rotational element having a second wireless module with a second antenna. The first and second antennae are aligned along the rotation axis and adapted to wirelessly communicate with each other.

### CROSS-REFERENCE TO RELATED APPLICATION

This application claims the benefit of U.S. Provisional Application No. 63/660,870 filed Jun. 17, 2024, the disclosure of which is expressly incorporated by reference herein in its entirety.

### BACKGROUND

### 1. Field of the Invention

The present teachings relate generally to rotational electromechanical systems and, more particularly, to alignment devices for rotary joints (slip rings, etc.) having wireless communication capabilities.

### 2. Discussion of Background Information

A rotary joint (also referred to as a slip ring), is an electromechanical device that allows the transmission of power and/or electronic signals from a stationary element to a rotating element. A slip ring can be used in any electromechanical system that requires rotation while transmitting power or signals. Slip rings can improve mechanical performance, simplify system operation, and eliminate damage-prone wires dangling from movable joints.

Also called rotary electrical interfaces, rotating electrical connectors, collectors, swivels, or electrical rotary joints, slip rings/rotary joints are commonly found in slip ring motors, electrical generators for alternating current (AC) systems, cable reels, and wind turbines. They can be used on any rotating object to transfer power, control circuits, or analog or digital signals, including data such as those found on aerodrome beacons, rotating tanks, power shovels, radio telescopes, telemetry systems, heliostats, and Ferris wheels, to name a few.

In a variety of technological contexts, machines need to collect information for proper decision-making based on corresponding control logic. For example, sensors such as temperature, speed, pressure, and other signal detectors can send information to a control unit of the machine, and the control unit can respond to the signals it receives by making adjustments, for example by regulating speed, adjusting pressure or pitch, etc. Video information is also an example of data that may be collected and sent for decision making processes based on character recognition, process changes, product condition, and other video analysis.

Complications are introduced when the transmission of such signals must be made between static and dynamic components, particularly where rotational motion is associated with the dynamic components. For conventional systems in which dynamic components are mounted to a rotor that rotates relative to static components supported on a stator, the rotor may move laterally (e.g., side-to-side, up and down, back and forth, etc.) during operation of the rotary joint, thereby causing the dynamic components mounted to the rotor to become misaligned from the static components supported on the stator. For example, unintended lateral movement of the rotor may be attributed to machining tolerances during manufacturing of the rotary joint.

At least one drawback to misalignment between the static and dynamic components is that wireless signals transmitted between misaligned static and dynamic components can be subjected to additional interference or even lost during transmission. For example, a signal transmitted by a wireless module included in the dynamic components may fail to reach and/or may fail to be received by a wireless module included in the static components while the dynamic components and static components are misaligned.

Therefore, it would be beneficial to have an alternative approach to aligning wireless communication in a rotary joint.

### SUMMARY

The needs set forth herein as well as further and other needs and advantages are addressed by the present embodiments, which illustrate solutions and advantages described below.

The present teachings relate to systems and devices for aligning wireless communication in a rotary joint. At least one technical advantage of the present teachings relative to the prior art solutions is that, with the present teachings, dynamic, or rotating, wireless modules and static, or non-rotating, wireless modules remain aligned during operation of the rotary joint. In this regard, the risk of losing signals transmitted between the rotating and non-rotating wireless modules during operation of the rotary joint is significantly reduced. At least another technical advantage of the present teachings relative to the prior art solutions is that, with the present teachings, power can be delivered wirelessly to a dynamic, or rotating, wireless module. In this regard, dynamic wireless modules can receive power in a contactless manner as opposed to relying on electrical connections formed between brushes and slip ring contacts.

One embodiment of a slip ring according to the present teachings includes, but is not limited to, a slip ring comprising a stator, a rotor configured to rotate relative to the stator about a rotation axis, and an alignment module mounted to the rotor. The alignment module includes a housing having a first wireless module with a first antenna and a support member configured to engage a surface of the first stator or a component disposed within the first stator. The alignment module further includes a rotational element coupled to the first rotor and configured to rotate about the rotation axis relative to the housing, the rotational element having a second wireless module with a second antenna. The first and second antennae are aligned along the rotation axis and adapted to wirelessly communicate with each other.

One embodiment of an alignment module according to the present teachings includes, but is not limited to, an alignment module comprising a housing and a rotational element. The housing includes a first wireless module with a first antenna and a support member configured to engage a surface of the rotary joint or a stationary component disposed within the rotary. The rotational element is configured to couple to a rotor of the rotary joint and rotate relative to the housing about a rotation axis, the rotational element having a second wireless module with a second antenna that is configured to rotate relative to the first wireless module. The first and second antennae are aligned along the rotation axis and adapted to wirelessly communicate with each other.

Another embodiment of a slip ring according to the present teachings includes, but is not limited to, a slip ring comprising a stator, a rotor configured to rotate relative to the stator about a rotation axis, and an alignment module mounted to the stator. The alignment module includes a housing having a first wireless module with a first antenna and a flange having a hole formed therein to receive a stator pin coupled to the stator. The alignment module further includes a rotational element coupled to the rotor and configured to rotate relative to the housing about the rotation axis, the rotational element having a second wireless module with a second antenna. The first and second antennae are aligned along the rotation axis and adapted to wirelessly communicate with each other.

Another embodiment of an alignment module according to the present teachings includes, but is not limited to, an alignment module comprising a housing and a rotational element. The housing includes a first wireless module with a first antenna and a flange having a hole formed therein to receive a stator pin coupled to the rotary joint. The rotational element is coupled to a rotor of the rotary joint and configured to rotate relative to the housing about a rotation axis, the rotational element having a second wireless module with a second antenna. The first and second antennae are aligned along the rotation axis and adapted to wirelessly communicate with each other.

One embodiment of a wireless power transfer circuit for a rotary joint according to the present teachings includes, but is not limited to, a wireless power transfer circuit comprising a power supply, a transmitter coil adapted to receive power from the power supply, a driving circuit adapted to control the transmitter coil to wirelessly transmit the power, and a receiver coil adapted to receive the power wirelessly transmitted by the transmitter coil and provide the received power to a wireless communication module.

Another embodiment of an alignment module according to the present teachings includes, but is not limited to, an alignment module comprising a first wireless module with a first antenna, a transmitter coil adapted to wirelessly transmit power, a rotational element coupled to a rotor of the rotary joint and configured to rotate relative to the housing, the rotational element including a second wireless module with a second antenna, and a receiver coil adapted to receive the power wirelessly transmitted by the transmitter coil and provide the received power to the second wireless module.

Another embodiment of an alignment module according to the present teachings includes, but is not limited to, an alignment module comprising a housing including a first wireless module with a first antenna, a rotational element coupled to a rotor of the rotary joint and configured to rotate relative to the housing, the rotational element including a second wireless module with a second antenna, and a first coil adapted to power the second wireless module with power wirelessly transmitted by a second coil. The second wireless module and the first coil are adapted to rotate with the rotational element.

Embodiments are directed to a rotary joint that includes a stator; a rotor configured to rotate relative to the stator about a rotation axis; and an alignment module mounted to the rotor, the alignment module including a housing having a first wireless module with a first antenna; and a rotational element coupled to the first rotor and configured to rotate about the rotation axis relative to the housing, the rotational element having a second wireless module with a second antenna. The first and second antennae are aligned along the rotation axis and adapted to wirelessly communicate with each other.

According to embodiments, the housing can further have a support member configured to engage a surface of the stator or a component disposed within the stator.

In other embodiments, the housing can include a flange having a hole formed therein to receive a stator pin coupled to the stator.

Embodiments are directed to an alignment module for wireless communication in a rotary joint that includes a housing including a first wireless module with a first antenna; and a rotational element configured to be coupled to a rotor of the rotary joint and rotate relative to the housing about a rotation axis, the rotational element having a second wireless module with a second antenna. The first and second antennae are aligned along the rotation axis and adapted to wirelessly communicate with each other.

In accordance with embodiments, the second antenna can be configured to rotate relative to the first wireless module.

According to other embodiments, the housing can include a support member configured to engage a surface of the rotary joint or a stationary component disposed within the rotary joint.

In other embodiments, the housing can include a flange having a hole formed therein to receive a stator pin coupled to the rotary joint. The alignment module can also include a transmitter coil adapted to wirelessly transmit power; and a receiver coil adapted to receive the power wirelessly transmitted by the transmitter coil and to provide the received power to the second wireless module. Moreover, the second wireless module and the receiver coil can be adapted to rotate with the rotational element.

In still other embodiments, the alignment module can further include a transmitter coil adapted to wirelessly transmit power; and a receiver coil adapted to receive the power wirelessly transmitted by the transmitter coil and to provide the received power to the second wireless module. Further, the second wireless module and the receiver coil may be adapted to rotate with the rotational element.

According to further embodiments, a first coil can be adapted to power the second wireless module with power wirelessly transmitted by a second coil. The second wireless module and the first coil can be adapted to rotate with the rotational element.

Still further, a rotary joint can include a stator; a rotor configured to rotate relative to the stator about a rotation axis; and an alignment module, as described above, mounted to the rotor.

Embodiments are directed to a wireless power transfer circuit for a rotary joint that includes a power supply; a transmitter coil adapted to receive power from the power supply; a driving circuit adapted to control the transmitter coil to wirelessly transmit the power; and a receiver coil adapted to receive the power wirelessly transmitted by the transmitter coil and to provide the received power to a wireless communication module.

For a better understanding of the present embodiments, together with other and further aspects thereof, reference is made to the accompanying drawings and detailed description, and its scope will be pointed out in the appended claims.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a block diagram depicting connections and components of an example wireless platform for use in a rotary joint, in accordance with the present teachings.

FIG. 2 is a block diagram of an example rotary joint, in accordance with the present teachings.

FIG. 3 is a sectional view of an embodiment of a rotary joint that does not include an alignment module, in accordance with the present teachings.

FIG. 4 is a sectional of the rotary joint of FIG. 3 in which the rotor antenna and the stator antenna are misaligned, in accordance with the present teachings.

FIG. 5 is a sectional view of an embodiment of a rotary joint that includes a rotor mounted alignment module, in accordance with the present teachings.

FIG. 6 is a perspective view of the rotor mounted alignment module shown in FIG. 5, in accordance with the present teachings.

FIG. 7 is a sectional view of the rotor mounted alignment module shown in FIG. 5, in accordance with the present teachings.

FIG. 8 is a perspective view of the rotor mounted alignment module shown in FIG. 5 installed in a rotary joint, in accordance with the present teachings.

FIG. 9 is a sectional view of an embodiment of a rotary joint in which the rotor antenna and the stator antenna are misaligned, in accordance with the present teachings.

FIG. 10 is a sectional view of an embodiment of a rotary joint that includes a stator mounted alignment module, in accordance with the present teachings.

FIG. 11 is a perspective view of the stator mounted alignment module shown in FIG. 10, in accordance with the present teachings.

FIG. 12 is a sectional view of the stator mounted alignment module shown in FIG. 10, in accordance with the present teachings.

FIG. 13 is a sectional view of the stator mounted alignment module shown in FIG. 10 installed in a rotary joint, in accordance with the present teachings.

FIG. 14A illustrates a sectional view of an example alignment module in which power is provided to a dynamic wireless module via a wireless power transfer circuit, in accordance with the present teachings.

FIG. 14B illustrates a sectional view of an example alignment module in which power is provided to a dynamic wireless module via a wireless power transfer circuit, in accordance with the present teachings.

FIG. 15 illustrates a perspective view of example transmitter and receiver coils that may be implemented in wireless power transfer circuit of FIGS. 14A and 14B, according to the present teachings.

FIG. 16A illustrates an example rotary joint in which an alignment module that includes a wireless power transfer circuit has been installed, in accordance with the present teachings.

FIG. 16B illustrates an example rotary joint in which an alignment module that does not include a wireless power transfer circuit has been installed, in accordance with the present teachings.

### DETAILED DESCRIPTION

The present teachings are described more fully hereinafter with reference to the accompanying drawings, in which the present embodiments are shown. The following description is presented for illustrative purposes only and the present teachings should not be limited to these embodiments. Any computer configuration and architecture satisfying the speed and interface requirements herein described may be suitable for implementing the system and method of the present embodiments.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect.

For purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail.

A “computing system” may provide functionality for the present teachings. The computing system may include software executing on computer readable media that may be logically (but not necessarily physically) identified for particular functionality (e.g., functional modules). The computing system may include any number of computers/processors, which may communicate with each other over a network. The computing system may be in electronic communication with a datastore (e.g., database) that stores control and data information. Forms of computer readable media include, but are not limited to, disks, hard drives, random access memory, programmable read only memory, or any other medium from which a computer can read.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components.

To aid the Patent Office and any readers of a patent issued on this application in interpreting the claims appended hereto, it is noted that none of the appended claims or claim elements are intended to invoke 35 U.S.C. 112 (f) unless the words “means for” or “step for” are explicitly used in the particular claim.

Recitations of numerical ranges by endpoints include all numbers within that range (e.g., 1 to 5 includes 1, 1.5, 2, 2.75, 3, 3.80, 4, 5, etc.). Where a range of values is “greater than”, “less than”, etc., of a particular value, that value is included within the range.

Any direction referred to herein, such as “top,” “bottom,” “left,” “right,” “upper,” “lower,” “above,” below,” and other directions and orientations are described herein for clarity in reference to the figures and are not to be limiting of an actual device or system or use of the device or system. Many of the devices, articles, or systems described herein may be used in a number of directions and orientations.

Any citation to a reference in this disclosure or during the prosecution thereof is made out of an abundance of caution. No citation (whether in an Information Disclosure Statement or otherwise) should be construed as an admission that the cited reference qualifies as prior art or comes from an area that is analogous or directly applicable to the present teachings.

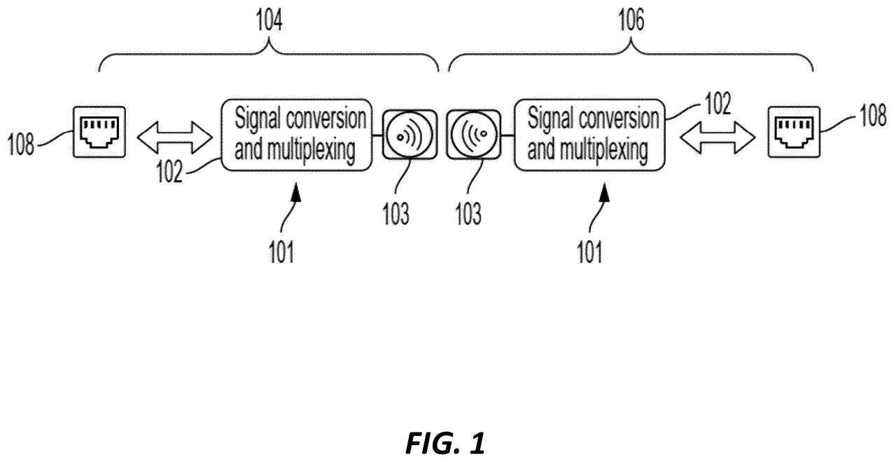

Referring now to FIG. 1, shown is a block diagram depicting connections and components of an example embodiment of a wireless platform for use in a rotary joint. In FIG. 1, a single communication channel (e.g., Ethernet channel) is utilized. However, in other examples, multiple communication channels can be utilized. Each of the static and dynamic sections of the rotary joint includes a wireless converter module 101, which includes a signal converter module 102, among other components, and an antenna 103. The signal converter module 102 acts as a signal conditioner and converter as well as a networking interface, although not limited thereto. It may include various functionality such as multiplexing, filtering, converting, calculating, and others, as is appreciated by one skilled in the art.

Pairs of wireless converter modules 101 are used in a rotary joint to effect communication between a stationary machine component or stator 106, and a rotating machine component or rotor 104. In the embodiment shown, each communication channel is denoted by a connector 108, which is communicatively and physically associated with the respective wireless converter module 101. For example, the connector 108 may include an Ethernet connector or any other form of connector that permits the desired communication, as is appreciated by one skilled in the art.

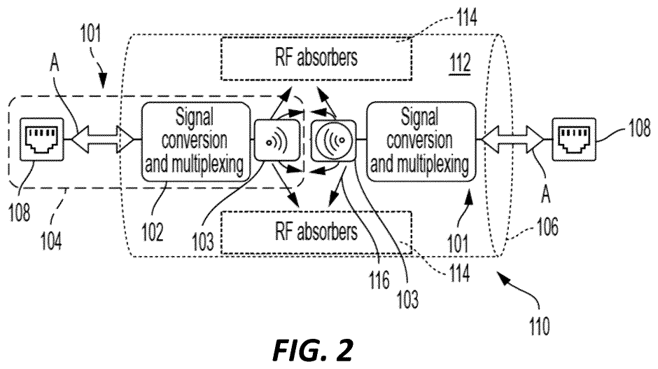

Referring now to FIG. 2, shown is a block diagram of a rotary joint in accordance with the present teachings. As shown, one or more connectors 108 can be disposed in connection with a wireless converter module 101 on a rotor 104 (denoted by dashed lines) and corresponding one or more connectors 108 can be disposed in connection with a second wireless converter module 101 on a stator 106 of a rotary joint 110.

In the embodiment shown in FIG. 2, the rotary joint 110 includes a stator 106 having a generally hollow cylindrical shape that creates an internal cavity 112, in which at least a portion of the rotor 104 is disposed. While a cylindrical cavity 112 is shown in this embodiment, it is appreciated that stators of any shape having cavities of any shape can also be used. The antenna 103 of the rotor 104 and the antenna 103 of the stator 106 are in facing relation and both are coaxially arranged along a rotation axis, A, of the rotor 104, and in facing relation within the cavity 112.

Optional absorbers or shields 114 (e.g., radio frequency, etc.) are disposed adjacent the antennae 103 in the cavity to reduce signal leakage. The shields 114 can prevent transmission of signals emitted by one of the antennae 103 in a one-way communication scheme, or signals emitted from both antennae 103 in a two-way communication scheme. The shields 114 can also reflect signals back to the antennae 103 to improve signal transmissivity, although not limited thereto.

During operation, one or more data signals are provided to a connector 108. The signal is then conditioned (e.g., in a known fashion) and provided to a signal conversion and multiplexer module, which in this case is the signal converter module 102, and then transmitted by the antenna 103 in any appropriate format.

In one example, the signal transmitted by the antenna 103 is processed through a 60 GHz chipset, although not limited thereto, and is also time divided through the signal converter module 102 (e.g., wireless converter module 101) for multiple data channels, which can be accomplished up to an aggregate data speed of 6.25 Gbps or higher. The wireless transmission path is carried at a frequency that can be well above normal EMI/EMC interference bandwidths, which enables its use in high interference environments. Moreover, shields and other types of external structures can be used to prevent transmission of the wireless signals externally for reasons of avoiding interference with adjacent machines, ensuring signal integrity from a security standpoint, and the like. In addition, or alternatively, signal encryption may be used for wirelessly sent signals to maintain signal security and integrity.

In general, the wireless communications module 101 comprises wireless communications hardware (e.g., a printed circuit board) used for generating short-range wireless communication signals according to a protocol such as Wi-Fi, ZigBee, Bluetooth, wireless HDMI and/or the IEEE 802.11 standard, although not limited thereto. Such short-range wireless communication signals are transmitted and received through the antennae 103, via a wireless connection 116, to and from each of the stationary and rotating portions of the rotary joint 110.

The module 101 may comprise other functionality, including sensor information, data storage (memory), and processing capabilities. In this way, it may operate as a computing system for local processing of information beyond signal conversion and manipulation.

Signal connections from the system connected to the rotary joint may feed directly into the wireless communications module 101, such as Ethernet, EtherCAT, Profinet, and Profibus connections, although not limited thereto. Other signal connections, such as Can Bus, RS-232, RS-422, RS-485, video, optical, and analog signal connections can feed into the signal converter module 102, which conforms the signals to a format compatible with the wireless converter module 101 (e.g., an Ethernet format) and transmits the converted signals to the wireless converter module 101. It is appreciated that signal communications may not only be transmitted via the antenna, but also received through the antenna and processed by the wireless platform—i.e., Ethernet signals received via antenna 103 and wireless converter module 101 may be converted to appropriate non-Ethernet formats by the signal converter module 102 and sent to the system along the Can Bus, RS-232, RS-422, RS-485, video, optical, and/or analog signal connections, or not converted and sent to the system along the Ethernet, EtherCAT, Profinet, and/or Profibus connections, although not limited thereto.

It is appreciated that the above-described types of signal connections—i.e., Ethernet, EtherCAT, Profinet, Profibus, Can Bus, RS-232, RS-422, RS-485, video, optical, and analog—are merely examples of common types of signal connections, and that one skilled in the art appreciates that other types of signal connections may be used as well (with or without the signal converter module 102). Moreover, one skilled in the art would be able to implement variations of the exemplary configurations shown without departing from the principles of the present teachings. For example, the signal converter module 102 could be divided into separate signal converter modules for each type of signal, or the signal converter module and associated connection lines could be integrated with the Ethernet, EtherCAT, Profinet, and/or Profibus connection lines via a multiplexer circuit to multiplex all signals transmitted to and received from the wireless converter module 101. In another exemplary embodiment, multiple wireless converter modules could be used, or separate circuit boards could be stacked together to form the wireless converter module to accommodate varying bandwidth requirements. Because of the symmetry of the circuitry, either portion could be stationary, and the other portion could be rotatable.

In various examples, the wireless converter module 101 comprises a WiFi transceiver, a wireless Ethernet bridge or a custom-designed wireless module, and the signal converter module 102 is a digital parallel-to-serial converter, RS422-to-Ethernet converter, or a more custom approach to the conversion.

The exemplary wireless platforms shown (e.g., in FIGS. 1-2) further depict a respective antenna 103 that is part of each wireless converter module 101 for facilitating communications between each pair of modules 101.

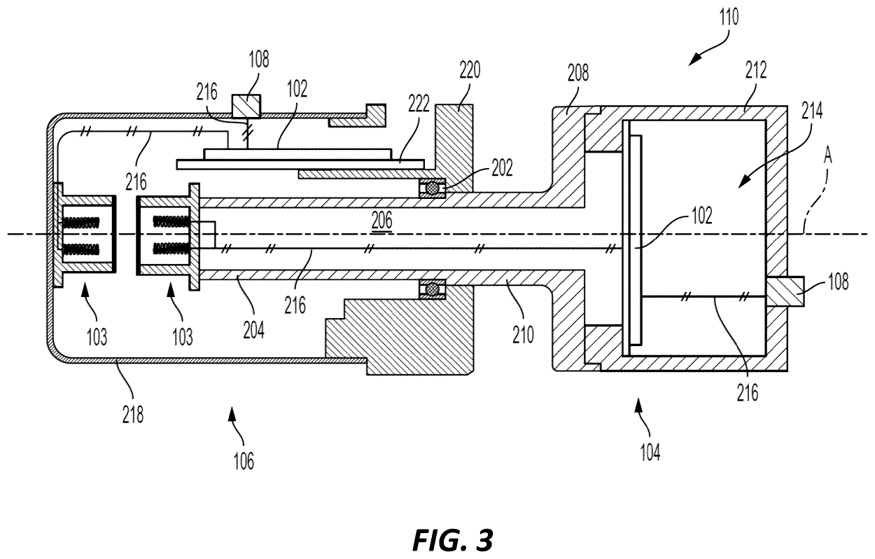

Referring now to FIG. 3, shown is a sectional view of an embodiment of a rotary joint that does not include an alignment module, in accordance with the present teachings. For simplicity, reference will be made in the description below to features and elements that are the same or similar to elements previously described using the same reference numerals as previously used. The rotary joint 110 includes a rotor 104 and a stator 106 that are rotatably connected to one another using a rotation enabling device, for example, one or more bearings 202 (only a single one shown here, although any number could be used such as 2, 3, 4, 5, 10, 15, 20, etc.).

The rotor 104 in the embodiment shown is a rotating assembly that includes a rotating shaft 204 forming a hollow interior cavity 206 that extends along an axis of rotation, A. At an external end, the rotor shaft 204 connects to a hub 208 via a neck extension 210. The hub includes a cover 212 having a hollow cup shape that defines a rotor housing 214. The rotor housing 214 is disposed around the signal converter module 102, which is connected via signal conductors 216 to the antenna 103 and to one or more connectors 108 (only one shown).

The stator 106 is a stationary assembly that includes a shell 218 having a generally hollow cylindrical shape that may be closed at one end, or open and closed with a cap. At an open end the shell 218 includes an axle mount 220 that supports the bearing 202 and, thus, the rotor shaft 204. The axle mount 220 further includes a shelf 222 onto which a second signal converter module 102 is mounted.

In the illustrated example of FIG. 3, the second signal converter module 102 is communicatively connected to a second antenna 103 via conductors 216. The second antenna 103 is disposed in the interior of the shell 218 and in aligned relation with the antenna 103 of the rotor 104 along the rotation axis A. The shell 218 and/or the axle mount 220 includes one or more connectors 108 that are also communicatively connected to the second signal converter 102 via conductors 216.

In the illustrated example of FIG. 3, both antennae 103 are polarized antennae as will be described hereinafter. The antennae in the present disclosure may be polarized antennas used in pairs, which enable the uninterrupted receipt of RF signals from the rotating antenna in the pair, which is associated with the rotor, to the stationary antenna in the pair, which is associated with the stator.

As used herein for some embodiments, polarization of the antenna 103 means the transmission and receipt of a signal provided by one antenna element along a polarization direction, and its receipt by another antenna element having the same polarization direction. One reason for polarization is to achieve reliable bi-directional signal transmission and receipt between the rotating and stationary portions of the slip ring assembly. Even though polarized antennas are shown, other bi-directional signal receipt and transmission structures and techniques can also be used. For example, angle of rotation-based frequency and/or amplitude modulation techniques can also be used. The polarization feature (as well as the other differentiation techniques) can also be used to transmit both signals in the same direction, thereby theoretically doubling the throughput capacity of the device.

In some examples, each antenna 103 may include two antenna elements, one of which is used for transmission and the other for receipt, although not limited thereto. It may be preferable to have a single pair of antennas used on either side of the wireless platform that can convey signals to/from each side in an uninterrupted fashion during rotation.

In many instances, during operation of the rotary joint 110 (e.g., as the rotor 104 rotates), the rotor 104 may move laterally (e.g., side-to-side, up and down, back and forth, etc.). For example, unintended lateral movement of the rotor 104 may be attributed to machining tolerances during manufacturing of the rotary joint 110. Such lateral movement of the rotor 104 causes the rotation axis A about which the rotor 104 rotates to tilt relative to the stator 106. Thus, when the rotation axis A tilts relative to the stator 106, the second antenna 103 disposed in the interior of the shell 218 is no longer aligned the antenna 103 of the rotor 104 along the rotation axis A. Rather, the antenna 103 of the rotor 104 and the second antenna 103 supported on the stator 106 become misaligned during lateral movement of the rotor 104.

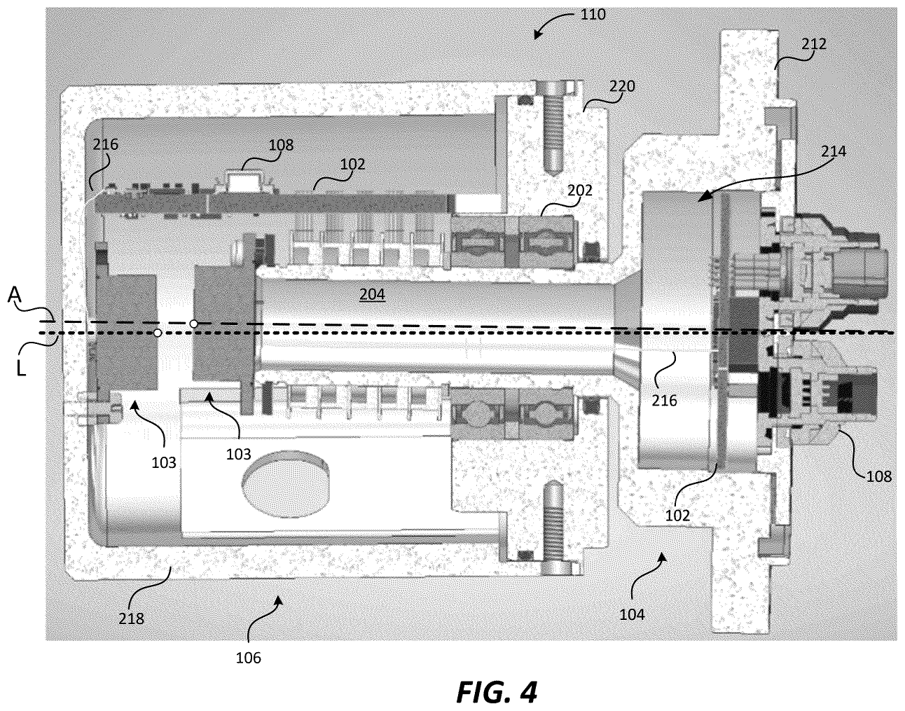

FIG. 4 is a sectional view of the rotary joint 110 of FIG. 3 in which the antenna 103 of the rotor 104 and the second antenna 103 of the stator 106 are misaligned, in accordance with the present teachings. As shown in FIG. 4, the antenna 103 of the rotor 104 is aligned with the rotation axis A of the rotor 104, which is tilted relative to the stator 106. In contrast, the antenna of the stator 106 is aligned with a longitudinal axis L of the stator 106.

As described herein, at least one drawback to misalignment between the antenna 103 of the rotor 104 and the antenna 103 of the stator 106 is that wireless signals transmitted between the antennae 103 can be subjected to additional interference and/or even lost during transmission. For example, a signal transmitted by the antenna 103 of the rotor 104 may fail to reach and/or may fail to be received by the antenna 103 of the stator 106 when the antennae 103 are misaligned. Similarly, as another example, a signal transmitted by the antenna 103 of the stator 106 may fail to reach and/or may fail to be received by the antenna 103 of the rotor 104 when the antennae 103 are misaligned.

In accordance with the present teachings, one or more alignment devices, or modules, can be used to prevent misalignment between dynamic (e.g., rotor mounted and/or rotating) and static (e.g., non-rotating) wireless modules in a rotary joint. As will be described in more detail herein, in one example, an alignment module can be mounted to a rotor, such as the rotor 104, and used to prevent misalignment between a dynamic, or rotating, antenna and a static, or non-rotating, antenna. In another example, an alignment module can be mounted to a stator, such as the stator 106, to prevent misalignment between a dynamic, or rotating, antenna and a static, or non-rotating, antenna. In some examples, the alignment module can have a generally cylindrical shape. In such examples, the alignment module may be referred to as an “alignment puck” or a “puck.” In other examples, the alignment module can have a different shape.

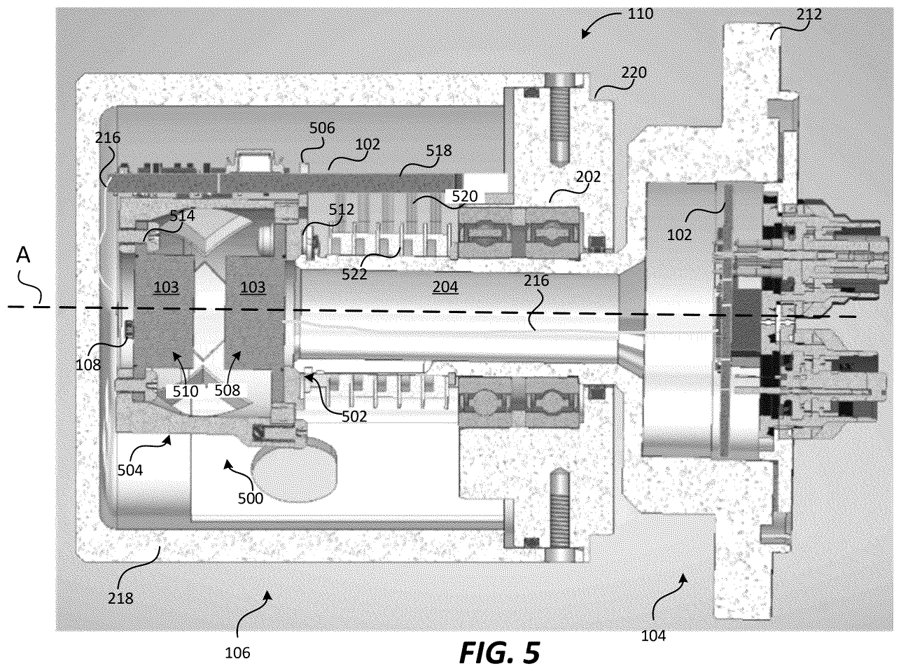

Referring now to FIG. 5, shown is a sectional view of an embodiment of a rotary joint that includes a rotor mounted alignment module 500, in accordance with the present teachings. For simplicity, reference will be made in the description below to features and elements that are the same or similar to elements previously described using some of the same reference numerals as previously used. For example, FIG. 5 shows a rotary joint 110. As described herein and shown in FIG. 5, the rotary joint 110 includes, among other things, a rotor 104 and a stator 106 that are rotatably connected to one another using a rotation enabling device such as one or more bearings 202 (only a single one shown here, although any number could be used such as 2, 3, 4, 5, 10, 15, 20, etc.).

In the illustrated example of FIG. 5, the rotor mounted alignment module 500 is generally cylindrical in shape. The rotor mounted alignment module 500 is mounted to, or installed on, the rotor 104 of the rotary joint 110 such that the rotor mounted alignment module 500 is disposed within an interior of the stator 106 of the rotary joint 110 (e.g., within the shell 218). For brevity, the rotor mounted alignment module 500 may hereinafter be referred to as a “rotor mounted puck 500” or more simply as the “puck 500.” Persons skilled in the art should understand that a cylinder is just one non-limiting example of a shape that can be used to implement the rotor mounted alignment module 500. Moreover, persons skilled in the art should understand that any description herein with reference to a cylindrical puck 500 is equally applicable to rotor mounted alignment module having a different shape.

The puck 500 includes a rotational element 502 and a non-rotating housing, or housing, 504. The rotational element 502 and the housing 504 are rotatably connected to one another using a rotation enabling device, such as but not limited to, one or more bearings. The puck 500 can be mounted to, or installed on, the rotor 104 via the rotational element 502 such that the rotational element 502 rotates about rotation axis A of the rotor 104. In that regard, while the puck 500 is mounted to the rotor 104, rotation of the rotor 104 causes simultaneous rotation of the rotational element 502. Accordingly, the rotational element 502 rotates with, not relative to, the rotor 104 about the rotation axis A.

In some examples, the rotational element 502 can be mounted to the rotor 104 of the rotary joint 110 using one or more fasteners (e.g., screws, bolts, etc.). In some examples, the rotational element 502 can be mounted, or coupled, to the rotor 104 of the rotary joint 110 using a friction fit and/or one or more engagement features formed in the rotational element 502 and/or the rotor 104. For example, a lip or protruding edge of the rotational element 502 may be configured to engage, or mate with, a channel formed in an outer surface of the rotor 104 to secure the rotational element 502 to the rotor 104. As another example, a lip or protruding edge of the rotor 104 may be configured to engage, or mate with, a channel formed in the rotational element 502 to secure the rotational element 502 to the rotor 104. In some examples, other suitable means can be used to secure the rotational element 502 to the rotor 104 such that the rotational element 502 and rotor 104 rotate in unison about the rotation axis A.

While the puck 500 is mounted to the rotor 104 (e.g., via the rotational element 502), the housing 504 does not rotate with the rotor 104 or the rotational element 502. Rather, the housing 504 remains stationary relative to the rotor 104. In that regard, the rotational element 502 and the rotor 104 rotate in unison about the rotation axis A relative to the housing 504.

As described above, in many instances, the rotor 104 may move laterally (e.g., side-to-side, up and down, back and forth, etc.) during operation of the rotary joint 110 (e.g., as the rotor 104 rotates). In such instances, while the puck 500 is mounted to the rotor 104, the housing 504 moves laterally with the rotor 104 but does not rotate. In that regard, the puck 500 moves laterally relative to the stator 106 as the rotor 104 moves laterally relative to the stator 106. Moreover, the housing 504 does not move laterally relative to the rotor 104.

In some examples, the puck 500 includes one or more support members 506 that are configured to engage one or more surfaces within the stator 106 and/or one or more components disposed within an interior of the stator 106. As the rotor 104 and puck 500 move laterally (e.g., side-to-side, up and down, back and forth, etc.) within the interior of the stator 106, the engagement between the one or more support members 506 and the one or more surfaces of and/or components disposed within the stator 106 can reduce the amount by which the puck 500 and rotor 104 move. In that regard, the one or more support members 506 are configured to support the position of the puck 500 within the interior of the stator 106 by reducing lateral movement of the puck 500 and the rotor 104 during operation of the rotary joint 110.

In the illustrated example of FIG. 5, the one or more support members 506 comprise an upright structure that extends vertically upward from the housing 504. The upright structure includes opposing posts that surround and engage the printed circuit board (PCB) 518 on which the signal converter module 102 is mounted. In operation of the rotary joint 110, engagement between the upright structure included in the support members 506 and the sides of the PCB 518 reduce side-to-side lateral movement of the puck 500 and the rotor 104.

As further shown in the illustrated example of FIG. 5, the puck 500 includes a dynamic wireless module 508 and a static wireless module 510. In the illustrated example of FIG. 5, the dynamic and static wireless modules 508, 510 are disposed within an interior of the housing 504. However, in other examples, the dynamic wireless module 508 and/or the static wireless module 510 can be mounted and/or positioned external to the interior of the housing 504. For example, the static wireless module 510 may be mounted to or otherwise supported on an exterior surface of the housing 504. As another example, the dynamic wireless module 508 can be mounted to or otherwise supported on the rotational element 502 and/or rotor 104 in a position exterior to the housing 504.

The dynamic wireless module 508 is mounted to, or otherwise secured on, the rotational element 502 and the static wireless module 510 is mounted to, or otherwise secured on, an interior surface of the housing 504. In that regard, the dynamic, or rotating, wireless module 508 is configured to rotate with the rotational element 502 about the rotation axis A and the static, or non-rotating, wireless module 510 is not configured to rotate about the rotation axis A. Rather, the static wireless module 510 remains stationary as the dynamic wireless module 508 rotates with the rotational element 502. In some examples, the dynamic wireless module 508 is mounted to the rotational element 502 such that the dynamic wireless module 508 is centered on the rotational element 502. In some examples, the static wireless module 510 is mounted to the interior surface of the housing 504 such that the static wireless module 510 is centered with respect to the interior surface of the housing 504.

In the illustrated example of FIG. 5, the dynamic wireless module 508 is mounted to the rotational element 502 using a first one or more fasteners 512 (e.g., screws, bolts, pins, etc.) and the static wireless module 510 is mounted to the interior surface of the housing 504 via a second one or more fasteners 514 (e.g., screws, bolts, pins, etc.). In some examples, the dynamic wireless module 508 can be coupled to the rotational element 502 and/or the static wireless module 510 can be coupled to the interior surface of the housing 504 using one or more other coupling mechanisms and/or methods.

As further shown in the illustrated example of FIG. 5, puck 500 is centered along the rotation axis A of the rotor 104. For example, the rotational element 502 and the housing 504 of the puck 500 are respectively centered on the rotation axis A of the rotor 104. Moreover, the dynamic wireless module 508, which is centered on the rotational element 502, and the static wireless module 510, which is centered on the interior surface of the housing 504, are both centered on the rotation axis A of the rotor 104. In that regard, the dynamic and static wireless modules 508, 510 are aligned with each other along the rotation axis A of the rotor 104.

Importantly, as described herein, the puck 500 does not move laterally relative to the rotor 104 as the rotor 104 moves laterally (e.g., side-to-side, up and down, back and forth, etc.) within an interior of the stator 106. Rather, the puck 500 moves laterally, in unison, with the rotor 104 as the rotor 104 moves laterally within an interior of the stator 106. In that regard, the dynamic and static wireless modules 508, 510 remain aligned with each other along the rotation axis A of the rotor 104 even as the rotor 104 moves laterally (e.g., side-to-side, up and down, back and forth, etc.) within an interior of the stator 106. For example, the dynamic wireless module 508 remains centered on the rotation axis A as the rotor 104 moves laterally because the dynamic wireless module 508 is mounted to the rotational element 502, which as described herein, is mounted to the rotor 104. Similarly, the static wireless module 510 remains centered on the rotation axis A as the rotor 104 moves laterally because the static wireless module 510 is mounted to a surface of the housing 504. Therefore, lateral movement of the rotor 104 during operation of the rotary joint 110 does not cause misalignment between the dynamic and static wireless modules 508, 510.

The dynamic wireless module 508 and the static wireless module 510 are similar to the wireless converter modules 101 described herein. For example, the dynamic and static wireless modules 508, 510 each include and/or are coupled to a respective signal converter module 102. In some examples, the dynamic and static wireless modules 508, 510 are coupled to the respective signal converter modules 102 via one or more conductors 216. In other examples, the dynamic and static wireless modules 508, 510 are coupled to the respective signal converter modules 102 via one or more wireless connections.

In some examples, the respective signal converter modules 102 are integrated within the dynamic and static wireless modules 508, 510. For example, a signal converter module 102 may be integrated within and/or internal to the dynamic wireless module 508. In such examples, the dynamic wireless module 508 and the signal converter module 102 can be implemented as a single component. As another example, a signal converter module 102 may be integrated within and/or internal to the static wireless module 510. In such examples, the static wireless module 510 and the signal converter module 102 can be implemented as a single component.

Moreover, the dynamic and static wireless modules 508, 510 each include one or more respective antennae 103. As shown in the illustrated example of FIG. 5, the antenna 103 of the dynamic wireless module 508 and the antenna 103 of the static wireless module 510 are in facing relation and both are coaxially arranged along a rotation axis A of the rotor 104. For example, the antennae 103 of the static and dynamic wireless modules 508, 510 are aligned with each other along the rotation axis A.

As described herein, the puck 500 maintains alignment between the dynamic and static wireless modules 508, 510 as the rotor 104 moves laterally within the interior of stator 106. In that regard, the puck 500 also maintains alignment between the antenna 103 of the dynamic wireless module 508 and the antenna 103 of the static wireless module 510 as the rotor 104 moves laterally within the interior of the stator 106. This alignment between the antennae 103 of the dynamic and static wireless modules 508, 510 allows for a higher success rate of wireless signal transmissions between the antennae 103 of the dynamic and static wireless modules 508, 510.

As further shown in FIG. 5, the static wireless module 510 is coupled to the PCB 518 on which the signal converter module 102 is mounted by one or more conductors, or cables, 216. One or more of the cables 216 can transfer wireless signals received by the antenna 103 included in the static wireless module 510 to the signal converter module 102. Moreover, the signal converter module 102 can transmit signals to the antenna 103 of the static wireless module 510 via the one or more cables 216. In addition, one or more of the cables 216 can be used to deliver power from the PCB 518 to the static wireless module 510. For example, one or more cables 216 deliver power to the static wireless module 510 via a connector 108 coupled to the static wireless module 510. In that regard, the static wireless module 510 receives operational power from the PCB 518 via the one or more cables 216.

In the illustrated example of FIG. 5, power is delivered from the PCB 518 to the dynamic wireless module 508 via one or more brushes 520. As shown, the one or more brushes 520 are in electrical contact with the dynamic wireless module 508 via one or more slip ring contacts 522. In that regard, the dynamic wireless module 508 receives operational power from the PCB 518 via the physical contact between one or more brushes 520 and slip ring contacts 522. One or more cables 216 connected between the dynamic wireless 508 and the signal converter module 102 can transfer wireless signals received by the antenna 103 included in the dynamic wireless module 508 to the signal converter module 102. Moreover, the signal converter module 102 can transmit signals to the antenna 103 of the dynamic wireless module 508 via the one or more cables 216.

As will be described in more detail herein, in some embodiments, a wireless power transfer circuit can be used to supply power to the dynamic wireless module 508. In such embodiments, the dynamic wireless module 508 does not rely on physical contact between the one or more brushes 520 and the one or more slip ring contacts 522 to receive operational power. Rather, in such embodiments, a receiver coil coupled to the dynamic wireless module 508 can receive power that is wirelessly transmitted by a transmitter coil.

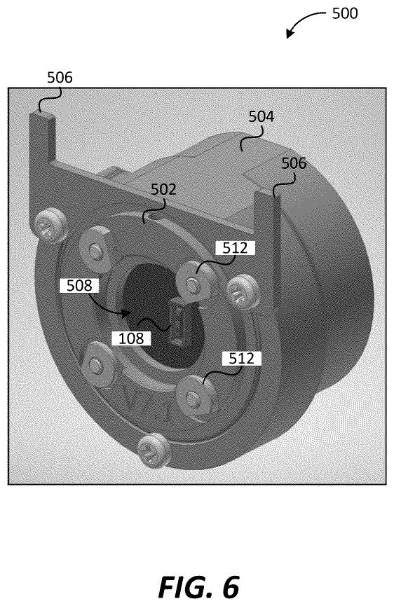

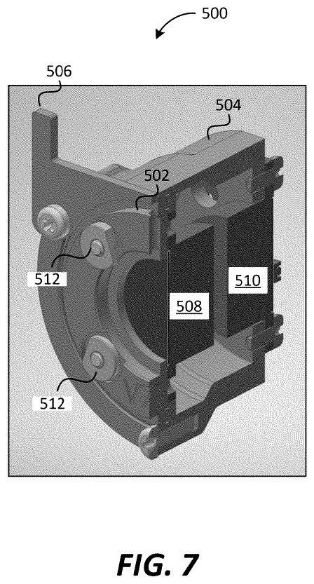

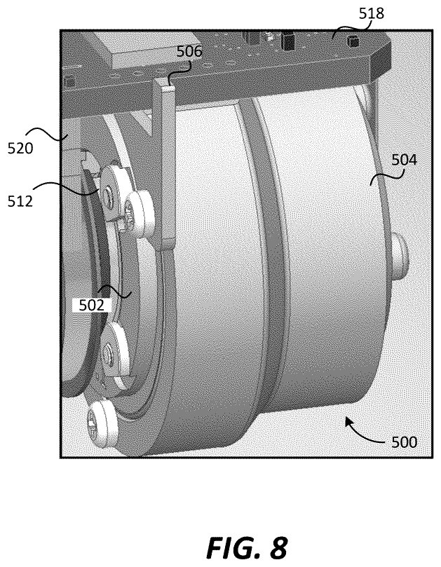

FIG. 6 is a perspective view of the rotor mounted alignment module 500, or puck 500, shown in FIG. 5, in accordance with the present teachings. FIG. 7 is a sectional view of the rotor mounted alignment module 500, or puck 500, shown in FIG. 5, in accordance with the present teachings. FIG. 8 is a perspective view of the rotor mounted alignment module 500, or puck 500, shown in FIG. 5 installed in a rotary joint, in accordance with the present teachings.

Although the rotor mounted puck 500 is shown as being installed or included in the rotary joint 110 in FIGS. 5 and 8, persons skilled in the art should understand that the rotor mounted puck 500 can be manufactured and/or sold separately from the rotary joint 110. For example, a rotary joint 110 may be manufactured and/or sold without a rotor mounted puck 500, a dynamic wireless module 508, and/or a static wireless module 510. In such an example, a rotor mounted puck 500 can later be installed in the rotary joint 110 to provide wireless data communication between dynamic components (e.g., the rotor 104) and static components (e.g., the stator 106) of the rotary joint 110. In that regard, wireless communication can be added to a rotary joint 110 by installing a rotor mounted puck 500 in the rotary joint 110. In some examples, the rotor mounted puck 500 is included in the rotary joint 110 at the time of manufacture of the rotary joint 110.

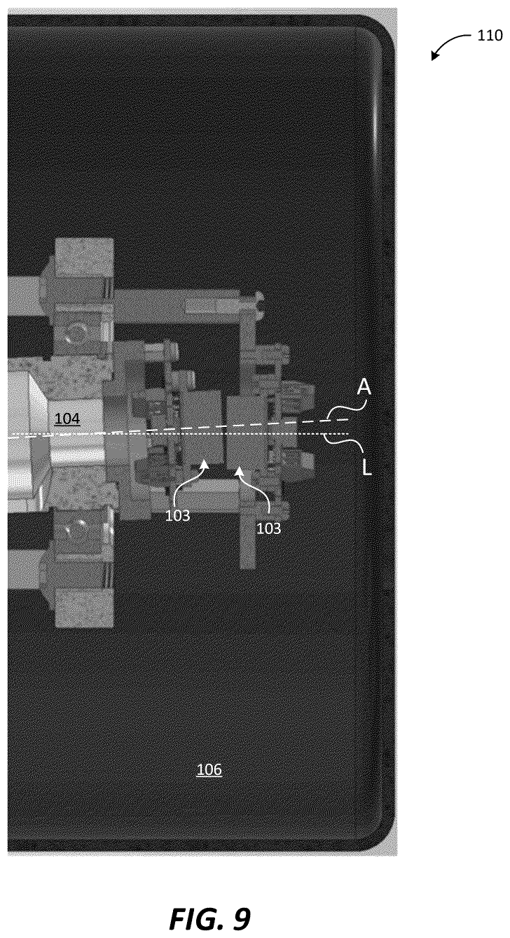

FIG. 9 is a sectional view of an embodiment of a rotary joint 110 in which a rotor antenna and the stator antenna are misaligned, in accordance with the present teachings. As shown in FIG. 9, an antenna 103 of the rotor 104 is aligned with the rotation axis A of the rotor 104, which is tilted relative to the stator 106. In contrast, an antenna 103 of the stator 106 is aligned with a longitudinal axis L of the stator 106.

As described herein, at least one drawback to misalignment between the antenna 103 of the rotor 104 and the antenna 103 of the stator 106 is that wireless signals transmitted between antennas 103 can be subjected to additional interference and/or even lost during transmission. For example, a signal transmitted by the antenna 103 of the rotor 104 may fail to reach and/or may fail to be received by the antenna 103 of the stator 106 when the antennas 103 are misaligned. Similarly, as another example, a signal transmitted by the antenna 103 of the stator 106 may fail to reach and/or may fail to be received by the antenna 103 of the rotor 104 when the antennas 103 are misaligned.

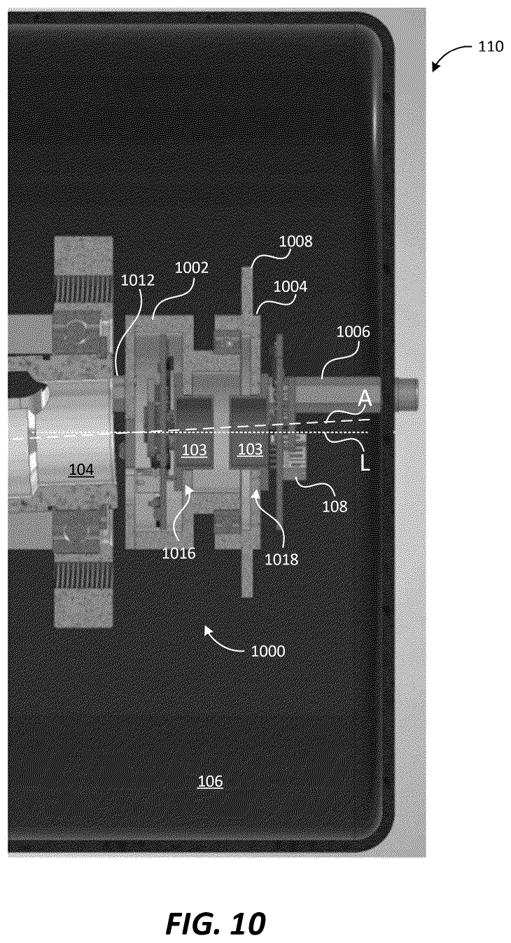

Referring now to FIG. 10, shown is a sectional view of an embodiment of a rotary joint 110 that includes a stator mounted alignment module 1000, in accordance with the present teachings. For simplicity, reference will be made in the description below to features and elements that are the same or similar to elements previously described using some of the same reference numerals as previously used. For example, FIG. 10 shows a rotary joint 110. As described herein and shown in FIG. 10, the rotary joint 110 includes, among other things, a rotor 104 and a stator 106 that are rotatably connected to one another using a rotation enabling device such as one or more bearings.

In the illustrated example of FIG. 10, the stator mounted alignment module 1000 is generally cylindrical in shape. The stator mounted alignment module 1000 is disposed within and mounted to, or installed on, an interior surface of the stator 106. In the illustrated example of FIG. 10, the stator mounted alignment module 1000 is mounted to a rear surface of the stator. However, in other examples, the stator mounted alignment module 1000 can be mounted to a different surface of the stator 106.

For brevity, the stator mounted alignment module 1000 may hereinafter be referred to as a “stator mounted puck 1000” or more simply as the “puck 1000.” Persons skilled in the art should understand that a cylinder is just one non-limiting example of a shape that can be used to implement the stator mounted alignment module 1000. Moreover, persons skilled in the art should understand that any description herein with reference to a cylindrical puck 1000 is equally applicable to stator mounted alignment module having a different shape.

The puck 1000 includes a rotational element 1002 and a non-rotating housing, or housing, 1004. The rotational element 1002 and the housing 1004 are rotatably connected to one another using a rotation enabling device, such as but not limited to, one or more bearings. In that regard, the rotational element 1002 can rotate relative to the housing 1004 while the housing 1004 remains stationary.

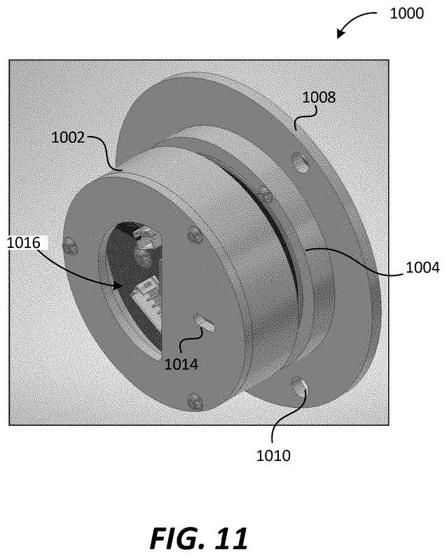

The puck 1000 can be mounted to, or installed on, the stator 106 via one or more stator pins 1006 such that the puck 1000 is fixed, or stationary, relative to the stator 106. For example, the housing 1004 includes a flange 1008 that extends outward from and surrounds the housing 1004. This flange 1008 includes one or more mounting holes 1010 (FIG. 11) formed therein that are arranged to receive corresponding one or more stator pins 1006. In that regard, the one or more stator pins 1006 mount the puck 1000 to the stator 106 via the flange 1008. In some examples, the puck 1000 and/or housing 1004 can be mounted to the stator 106 using one or more other fastening mechanisms.

While the puck 1000 is mounted to, or installed on, the stator 106, the rotational element 1002 of the puck 1000 can be coupled to the rotor 104 of the rotary joint 110 via a rotation pin 1012. For example, the rotational element 1002 includes a pin slot 1014 (FIG. 11) that is configured to receive a rotation pin 1012 that extends outward from an end of the rotor 104. While the rotation pin 1012 is received in the pin slot 1014, rotation of the rotor 104 causes the rotation pin 1012 to engage an inner surface of the pin slot 1014. This engagement between the rotation pin 1012 and the inner surface of the pin slot 1014 during rotation of the rotor 104 drives rotation of the rotational element 1002. In that regard, rotation of the rotor 104 during operation of the rotary joint 110 causes, via the rotation pin 1012, corresponding rotation of the rotational element 1002 of the puck 1000.

As the rotation pin 1012 drives rotation of the rotational element 1002, the housing 1004 of the puck 1000 does not rotate. Rather, the housing 1004 remains stationary relative to the stator 106 as the rotor 104 drives rotation of the rotational element 1002. Moreover, as the rotation pin 1012 drives rotation of the rotational element 1002, the rotational element 1002 does not move laterally relative to the housing 1004. Rather, the rotational element 1002 rotates in unison with the rotor 104 relative to the housing 1004 while remaining fixed laterally with respect to the housing 1004 and the stator 106.

As described above, in many instances, the rotor 104 may move laterally (e.g., side-to-side, up and down, back and forth, etc.) during operation of the rotary joint 110 (e.g., as the rotor 104 rotates). In such instances, while the puck 1000 is mounted to the stator 1006 and the rotation pin 1012 is engaged with the pin slot 1014 of the rotational element 1002, the rotation pin 1012 continues to drive rotation of the rotational element 1002 while the puck 1000 remains stationary relative to the stator 106. In that regard, lateral movement of the rotor 104 does not cause lateral movement of the puck 1000. Rather, the one or more stator pins 1006 secure the puck 1000 in a fixed position relative to the rotor 104 even as the rotor 104 moves laterally while driving rotation of the rotational element 1002.

Importantly, the rotational element 1002 does not move laterally with the rotor 104 even when the rotation pin 1012 is received in the pin slot 1014. Rather, the lateral position of the rotational element 1002 remains fixed during lateral movement of the rotor 104 because the rotation pin 1012 is free to articulate within the pin slot 1014 during lateral movement of the rotor 104. As shown in FIG. 10, as the rotation axis A of the rotor 104 tilts during lateral movement of the rotor 104, the rotational element 1002 and the housing 1004 of the puck 1000 remain aligned along a longitudinal axis L of the stator 106. In that regard, the rotor 104 can drive rotation of the rotational element 1002 without causing the rotational element 1002 to move laterally relative to the housing 1004 and/or the stator 106.

As further shown in the illustrated example of FIG. 10, the puck 1000 includes a dynamic wireless module 1016 and a static wireless module 1018. The dynamic and static wireless modules 1016, 1018 are disposed both disposed within an interior of the puck 1000. The dynamic wireless module 1016 is mounted to, or otherwise secured on, the rotational element 1002 and the static wireless module 1018 is mounted to, or otherwise secured on, an interior surface of the housing 1004. In that regard, the dynamic, or rotating, wireless module 1016 is configured to rotate with the rotational element 1002 relative to the static, or non-rotating, wireless module 1018 during rotation of the rotor 104. The static wireless module 1018 remains stationary as the dynamic wireless module 1016 rotates with the rotational element 1002.

In the illustrated example of FIG. 10, the dynamic and static wireless modules 1016,1018 are disposed within an interior of the housing 1004. However, in other examples, the dynamic wireless module 1016 and/or the static wireless module 1018 can be mounted and/or positioned external to the interior of the housing 1004. For example, the static wireless module 1018 may be mounted to or otherwise supported on an exterior surface of the housing 1004. As another example, the dynamic wireless module 1016 can be mounted to or otherwise supported on the rotational element 1002 in a position exterior to the housing 1004.

As further shown in the illustrated example of FIG. 10, the dynamic and static wireless modules 1016, 1018 are aligned with each other along the longitudinal axis L of the stator 106. Importantly, as described herein, the rotational element 1002 does not move laterally relative to the housing 1004 or stator 106 as the rotor 104 moves laterally (e.g., side-to-side, up and down, back and forth, etc.) within an interior of the stator 106. Rather, the lateral position of the rotational element 1002 remains stationary relative to the housing 1004 and the stator 106 as the rotor 104 moves laterally within an interior of the stator 106. In that regard, the dynamic and static wireless modules 1016, 1018 remain aligned with each other along the longitudinal axis L of the stator 106 even as the rotor 104 moves laterally (e.g., side-to-side, up and down, back and forth, etc.) within an interior of the stator 106.

The dynamic wireless module 1016 and the static wireless module 1018 are similar to the wireless converter modules 101 described herein. Moreover, the dynamic wireless module 1016 and the static wireless module 1018 are similar to the dynamic wireless module 508 and the static wireless module 510 described herein. For example, the dynamic and static wireless modules 1016, 1018 each include and/or are coupled to a respective signal converter module 102. In some examples, the dynamic and static wireless modules 1016, 1018 are coupled to the respective signal converter modules 102 via one or more conductors 216. In other examples, the dynamic and static wireless modules 1016, 1018 are coupled to the respective signal converter modules 102 via one or more wireless connections.

In some examples, the respective signal converter modules 102 are integrated within the dynamic and static wireless modules 1016, 1018. For example, a signal converter module 102 may be integrated within and/or internal to the dynamic wireless module 1016. In such examples, the dynamic wireless module 1016 and the signal converter module 102 can be implemented as a single component. As another example, a signal converter module 102 may be integrated within and/or internal to the static wireless module 1018. In such examples, the static wireless module 1018 and the signal converter module 102 can be implemented as a single component.

Moreover, the dynamic and static wireless modules 1016, 1018 each include one or more respective antennae 103. As shown in the illustrated example of FIG. 10, the antenna 103 of the dynamic wireless module 1016 and the antenna 103 of the static wireless module 1018 are in facing relation and both are coaxially arranged along a longitudinal axis L of the stator 106. For example, the antennae 103 of the static and dynamic wireless modules 1016, 1018 are aligned with each other along the longitudinal axis L.

As described herein, the puck 1000 maintains alignment between the dynamic and static wireless modules 1016, 1018 as the rotor 104 moves laterally within the interior of stator 106. In that regard, the puck 1000 also maintains alignment between the antenna 103 of the dynamic wireless module 1016 and the antenna 103 of the static wireless module 1018 as the rotor 104 moves laterally within the interior of the stator 106. This alignment between the antennae 103 of the dynamic and static wireless modules 1016, 1018 allows for a higher success rate of wireless signal transmissions between the antennae 103 of the dynamic and static wireless modules 1016, 1018.

Similar to the static wireless module 510 described with respect to puck 500, in some examples, the static wireless module 1018 may be coupled to a PCB on which the signal converter module 102 is mounted by one or more conductors, or cables. For example, one or more cables may connect a PCB to the static wireless module 1018 via a connector 108 coupled to the static wireless module 1018. In such examples, the one or more of the cables can be used to deliver power from the PCB to the static wireless module 1018. In that regard, the static wireless module 1018 receives operational power from the PCB via the one or more cables.

Furthermore, similar to the dynamic wireless module 508 described with respect to puck 500, in some examples, power is delivered to the dynamic wireless module 1016 via one or more brushes. For example, one or more brushes may be placed in electrical contact with the dynamic wireless module 1016 via one or more slip ring contacts. In that regard, the dynamic wireless module 1016 may receive operational power via the one or more brushes and slip ring contacts. As will be described in more detail herein, in other embodiments, operational power can be delivered to the dynamic wireless module 1016 via a wireless power transfer circuit. In such embodiments, the dynamic wireless module 1016 does not rely on physical contact between the one or more brushes and the one or more slip ring contacts to receive operational power. Rather, in such embodiments, a receiving coil coupled to the dynamic wireless module 1016 can receive power that is wirelessly transmitted by a transmitting coil.

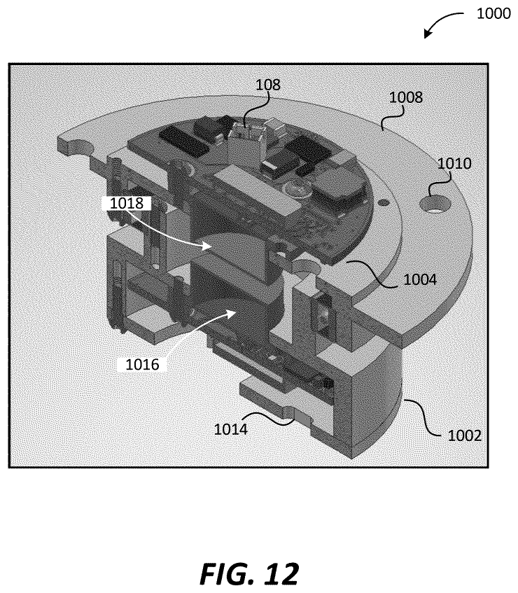

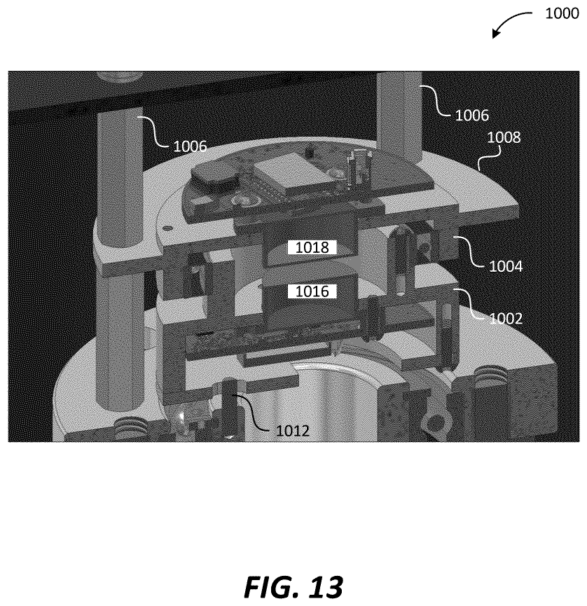

FIG. 11 is a perspective view of the stator mounted alignment module 1000 shown in FIG. 10, in accordance with the present teachings. FIG. 12 is a sectional view of the stator mounted alignment module 1000 shown in FIG. 10, in accordance with the present teachings. FIG. 13 is a sectional view of the stator mounted alignment module 1000 shown in FIG. 10 installed in a rotary joint 110, in accordance with the present teachings.

Although the stator mounted puck 1000 is shown as being installed or included in the rotary joint 110 in FIGS. 10 and 13, persons skilled in the art should understand that the stator mounted puck 1000 can be manufactured and/or sold separately from the rotary joint 110. For example, a rotary joint 110 may be manufactured and/or sold without a stator mounted puck 1000, a dynamic wireless module 1016, and/or a static wireless module 1018. In such an example, a stator mounted puck 1000 can later be installed in the rotary joint 110 to provide wireless data communication between dynamic components (e.g., the rotor 104) and static components (e.g., the stator 106) of the rotary joint 110. In that regard, wireless communication can be added to a rotary joint 110 by installing a stator mounted puck 1000 in the rotary joint 110. In some examples, the stator mounted puck 1000 is included in the rotary joint 110 at the time of manufacture of the rotary joint 110.

As described herein, in some embodiments, a wireless power transfer circuit can be used to supply power to a dynamic wireless module included in an alignment module, or puck, installed in a rotary joint. For example, a wireless power transfer circuit can be used to supply power to the dynamic wireless module 508 in the rotor mounted puck 500 and/or to supply power to the dynamic wireless module 1016 in the stator mounted puck 1000. In such embodiments, the dynamic wireless module (e.g., dynamic wireless module 508 and/or 1016) does not rely on physical contact between one or more brushes and one or more slip ring contacts to receive operational power. Rather, in such embodiments, a receiver coil coupled to a dynamic wireless module can receive power wirelessly from a transmitter coil.

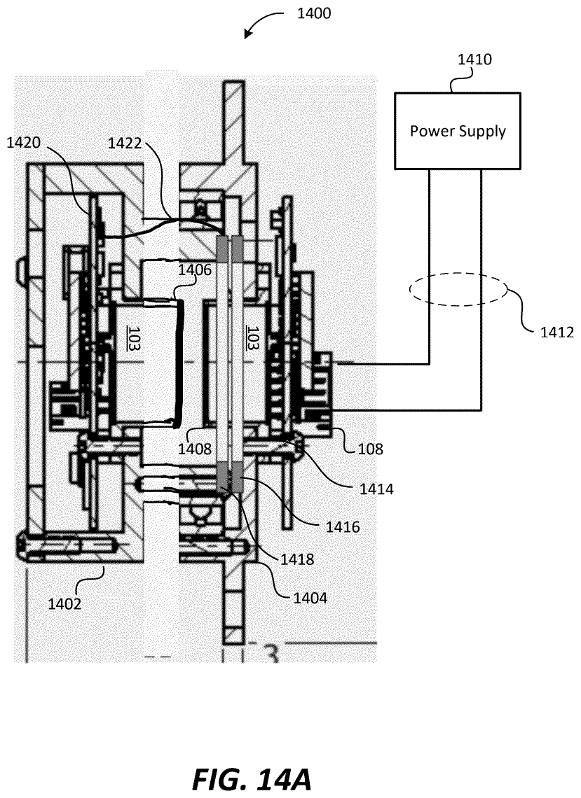

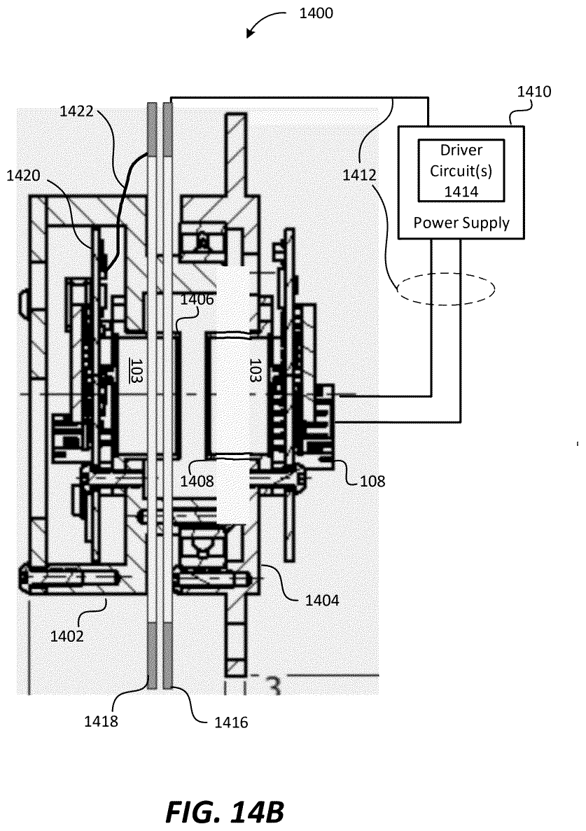

FIGS. 14A and 14B illustrate sectional views of example alignment modules, or pucks, 1400 in which power is provided to a dynamic wireless module via a wireless power transfer circuit, in accordance with the present teachings. The pucks 1400 shown in FIGS. 14A and 14B are similar in construction to the rotor mounted puck 500 and/or the stator mounted puck 1000 described herein. Moreover, the pucks 1400 may be implemented as using the rotor mounted puck 500 or the stator mounted puck 1000 described herein. In that regard, for simplicity, reference will be made in the description below to features and elements that are the same or similar to elements previously described using some of the same reference numerals as previously used. Hereinafter, the puck 1400 shown in FIG. 14A and/or the puck 1400 shown in FIG. 14B may collectively be referred to as the “puck 1400.”

The puck 1400 includes a rotational element 1402 and a non-rotating housing, or housing, 1404. The rotational element 1402 and the housing 1404 are rotatably connected to one another using a rotation enabling device, such as but not limited to, one or more bearings. Similar to the rotor mounted puck 500 described herein, in some examples, the puck 1400 can be mounted to, or installed on, the rotor 104 of the rotary joint 110 via the rotational element 1402. In other examples, similar to the stator mounted puck 1000 described herein, the puck 1400 can be mounted to, or installed on, the stator 106 of the rotary joint 110 via one or more stator pins and a flange.

As further shown in FIGS. 14A and 14B, the puck 1400 includes a dynamic wireless module 1406 and a static wireless module 1408. Similar to the dynamic wireless modules 508, 1016 described herein, the dynamic wireless module 1406 is mounted to, or otherwise secured on, the rotational element 1402. Similar to the static wireless modules 510, 1018 described herein, the static wireless module 1408 is mounted to, or otherwise secured on, an interior surface of the housing 1404 of the puck 1400. In that regard, the dynamic, or rotating, wireless module 1406 is configured to rotate with the rotational element 1402 and the static wireless module 1408 is not configured to rotate with the rotational element 1402. Rather, the static wireless module 1408 remains stationary as the dynamic wireless module 1406 rotates with the rotational element 1402. Importantly, similar to the pucks 500, 1000 described herein, the puck 1400 maintains alignment between the dynamic and static wireless modules 1406, 1408 even when the rotor 104 moves laterally within the stator 106 during operation of the rotary joint 110.

In the illustrated example of FIGS. 14A and 14B, the dynamic and static wireless modules 1406, 1408 are disposed within an interior of the rotating element 1402 and/or the housing 1404. However, in other examples, the dynamic wireless module 1406 and/or the static wireless module 1408 can be mounted and/or positioned external to the interior of the housing 1404. For example, the static wireless module 1406 may be mounted to or otherwise supported on an exterior surface of the housing 1404. As another example, the dynamic wireless module 1406 can be mounted to or otherwise supported on the rotational element 1402 in a position exterior to the housing 1404.

The dynamic wireless module 1406 and the static wireless module 1408 are similar to the wireless converter modules 101, described herein. Moreover, the dynamic wireless module 1406 and the static wireless module 1408 are similar to the dynamic wireless modules 508, 1016 and the static wireless modules 510, 1018 described herein. For example, the dynamic and static wireless modules 1406, 1408 each include and/or are coupled to a respective signal converter module 102. In some examples, the dynamic and static wireless modules 1406, 1408 are coupled to the respective signal converter modules 102 via one or more conductors.

In some examples, the respective signal converter modules 102 are integrated within the dynamic and static wireless modules 1406, 1408. For example, a signal converter module 102 may be integrated within and/or internal to the dynamic wireless module 1406. In such examples, the dynamic wireless module 1406 and the signal converter module 102 can be implemented as a single component. As another example, a signal converter module 102 may be integrated within and/or internal to the static wireless module 1408. In such examples, the static wireless module 1408 and the signal converter module 102 can be implemented as a single component.

Moreover, the dynamic and static wireless modules 1406, 1408 each include one or more respective antennae 103. As shown in the illustrated examples of FIGS. 14A and 14B, the antenna 103 of the dynamic wireless module 1406 and the antenna 103 of the static wireless module 1408 are in facing relation and both are coaxially arranged along the same axis. As described herein, the puck 1400 maintains alignment between the dynamic and static wireless modules 1406, 1408 as the rotor 104 moves laterally within the interior of stator 106. In that regard, the puck 1400 also maintains alignment between the antenna 103 of the dynamic wireless module 1406 and the antenna 103 of the static wireless module 1408 as the rotor 104 moves laterally within the interior of the stator 106. This alignment between the antennae 103 of the dynamic and static wireless modules 1406, 1408 allows for a higher success rate of wireless signal transmissions between the antennae 103 of the dynamic and static wireless modules 1406, 1408.

As further shown in FIGS. 14A and 14B, a power supply 1410 is coupled to the puck 1400 via one or more cables 1412. In some examples, the power supply 1410 may be included in the puck 1400. For example, the power supply 1410 may comprise one or more batteries and/or other power sources that are mounted to or otherwise supported on the puck 1400. In other examples, the power supply 1410 is external to the puck 1400 and coupled to the puck 1400 via the one or more cables 1412. For example, the power supply 1400, which can include and/or be coupled to one or more DC power sources and/or AC power sources, may be mounted within and/or otherwise supported by the rotary joint 110 in which the puck 1400 is installed. In such examples, the power supply 1400 can be connected to the puck 1400 via a connector 108 when the puck 1400 is installed in the rotary joint 110.

In operation of the rotary joint 110, the power supply 1410 provides operational power to the static wireless module 1408. For example, power delivered by the power supply 1410 to the static wireless module 1408 powers the antenna 103 during transmission and reception of the wireless signals. As further shown in FIGS. 14A and 14B, the power supply 1410 provides operational power to the dynamic wireless module 1406 via a wireless power transfer circuit. In that regard, power is delivered from the power supply 1410 to the static wireless module 1408 via the one or more cables 1412 and power is delivered from the power supply 1410 to the dynamic wireless module 1406 via one or more cables 1412 and the wireless power transfer circuit.

The wireless power transfer circuit includes one or more driver circuits 1414, a transmitter coil 1416, a receiver coil 1418, and one or more conversion circuits 1420. The one or more driver circuits 1414 are adapted to receive power from the power supply 1410, condition and/or convert the power received from the power supply 1410, and excite the transmitter coil 1416 to wirelessly transmit the conditioned and/or converted power to the receiver coil 1418. For example, the one or more driver circuits 1414 oscillate and/or otherwise control the frequency of the transmitter coil 1416 to cause the wireless transmission of power from the transmitter coil 1416 to the receiver coil 1418.

In some embodiments, the one or more driver circuits 1414 are included in and/or mounted to the puck 1400. For example, in the illustrated example of FIG. 14A, the one or more driver circuits 1414 may be included in a PCB mounted to the puck 1400 and/or the static wireless module 1408. In such examples, the one or more driver circuits 1414 may receive power from the power supply 1410 via a connector 108 coupled to the puck static wireless module 1408. In some embodiments, the one or more driver circuits 1414 are integrated within the power supply 1410. In such embodiments, the power supply 1410 may be coupled directly to the transmitter coil 1416. For example, in the illustrated example of FIG. 14B, the one or more driver circuits 1414 are included in the power supply 1410 and/or coupled between the power supply 1410 and the transmitter coil 1416. In some embodiments, the one or more driver circuits 1414 are external to the puck 1400. In such embodiments, the one or more driver circuits 1414 may be mounted to and/or otherwise supported by a surface and/or structure within the rotary joint 110.

The receiver coil 1418 is electrically coupled to the dynamic wireless module 1406 by, for example, one or more cables and/or other conductors. The receiver coil 1418 wirelessly receives power transmitted by the transmitter coil 1416 and provides the wirelessly received power to the dynamic wireless module 1406. The power provided by the receiver coil 1418 to the dynamic wireless module 1406 can be used to power the dynamic wireless module 1406 (e.g., power the antenna 103 included in the dynamic wireless module 1406, power the signal converter module 102 coupled to the dynamic wireless module 1406, etc.). In some examples, power received by the receiver coil 1418 is conditioned by the one or more conversion circuits 1420 before being provided to the dynamic wireless module 1406. The one or more conversion circuits 1420 may be, for example, mounted to a PCB supported on the rotational element 1402 and/or the dynamic wireless module 1406. In some examples, the one or more conversion circuits 1420 are further adapted to convert wireless signals received by the antenna 103 in the dynamic wireless module 1406 into a different signal format such as, but not limited to, Ethernet.

With the wireless power transfer circuit, the dynamic wireless module 1406 included in the puck 1400 can be powered without the use of brushes and/or slip ring contacts, thereby providing non-contact power to the dynamic wireless module 1406. Advantageously, by eliminating the need for brushes and slip ring contacts to provide power to the dynamic wireless module 1406, (i) extra brushes and/or slip ring contacts can be removed from the rotary joint 110 and (ii) a PCB and/or power supply circuit does not need to be placed within stator 106 of the rotary joint 110 proximate the rotor 104 and/or proximate the dynamic wireless module 1406.

In some examples, the transmitter and/or receiver coils 1416, 1418 can be mounted to or otherwise supported by the housing 1404 of the puck 1400. In some examples, the transmitter coil 1416 and/or the receiver coil 1418 may be supported by an interior surface of the stator 106 and/or a structure within the stator 106.

In some examples, such as in the illustrated example of FIG. 14A, the transmitter and/or receiver coils 1416, 1418 can be positioned proximate the static wireless module 1408. In the illustrated example of FIG. 14A, the transmitter and/or receiver coils 1416, 1418 may be secured to the housing 1404 proximate the static wireless module 1408 and/or secured to the static wireless module 1408 via one or more fasteners (e.g., screws, pins, etc.) and/or one or more adhesives. With respect to FIG. 14A, in some examples, while the receiver coil 1418 is positioned proximate the static wireless module 1408, the receiver coil 1418 is installed such that the receiver coil 1418 rotates relative to the transmitter coil 1416 with the dynamic wireless module 1406 and/or the rotational element 1402. In other examples, while the receiver coil 1418 is positioned proximate the static wireless module 1408, the receiver coil 1418 does not rotate. As shown in FIG. 14A, the receiver coil 1418 is coupled to the dynamic wireless module 1406 and/or the one or more conversion circuits 1420 via one or more cables 1422.

In some examples, such as in the illustrated example of FIG. 14B, the transmitter and/or receiver coils 1416, 1418 can be positioned proximate the dynamic wireless module 1406. In the illustrated example of FIG. 14B, the transmitter and/or receiver coils 1416, 1418 may be secured to the housing 1404 proximate the dynamic wireless module 1406 and/or secured to the static wireless module 1406 via one or more fasteners (e.g., screws, pins, etc.) and/or one or more adhesives. With respect to FIG. 14B, in some examples, the transmitter and receiver coils 1416, 1418 are installed such that both the transmitter and receiver coils 1416, 1418 are adapted to rotate with the rotational element 1402 and/or the dynamic wireless module 1406. In some examples, the transmitter and receiver coils 1416, 1418 are installed such that only the receiver coil 1418 is adapted to rotate with the rotational element 1402 and/or the dynamic wireless module 1406. In such examples, the receiver coil 1418 rotates relative to the transmitter coil 1416. The receiver coil 1418 is coupled to the dynamic wireless module 1406 and/or the one or more conversion circuits 1420 via one or more cables 1422.

As shown in the illustrated examples of FIGS. 14A and 14B, the transmitter coil 1416 may be aligned with and/or centered on an axis along which the dynamic and static wireless modules 1406, 1408 are aligned. As further shown in the illustrated examples of FIGS. 14A and 14B, the receiver coil 1418 may also be aligned with and/or centered on the same axis along which the dynamic and static wireless modules 1406, 1408 are aligned. In that regard, the transmitter and receiver coils 1416, 1418 are aligned with each other along the same axis (e.g., are concentric coils), thereby improving the efficiency at which power is transferred from the transmitter coil 1416 to the receiver coil 1418. In some examples, the transmitter and receiver coils 1416, 1418 are constructed and/or wound using copper wire.

Although shown as a single pair of coaxial coils in the illustrated examples of FIGS. 14A and 14B, the number of coaxially arranged transmitter and receiver coils 1416, 1418 can be increased to proportionally increase the amount of power that can be transferred from the transmitter coil 1416 to the receiver coil 1418. Depending on the application in which the rotary joint 110 and/or puck 1400 is implemented, the transmitter coil 1416 may transmit tens of watts, hundreds of watts, thousands of watts, or more to the receiver coil 1418.

In some examples, one or more elements of the puck 1400 are adapted to dissipate heat generated during power transmission between the transmitter and receiver coils 1416, 1418 away from the electronic components included in the dynamic and/or static wireless modules 1406, 1408. For example, the rotational element 1402 and/or the housing 1404 of the puck 1400 can be designed to function as a heat sink the conducts and dissipate heat away from the one or more driving circuits 1414, the transmitter coil 1416, and/or the receiver coil 1418 to one or more surfaces of the stator 106 and/or the air surrounding the puck 1400. In such examples, one or more elements of the puck 1400 (e.g., the rotational element 1402, the housing 1404, etc.) may be constructed from thermally conductive materials such as, but not limited to, aluminum, aluminum alloy, and/or copper.

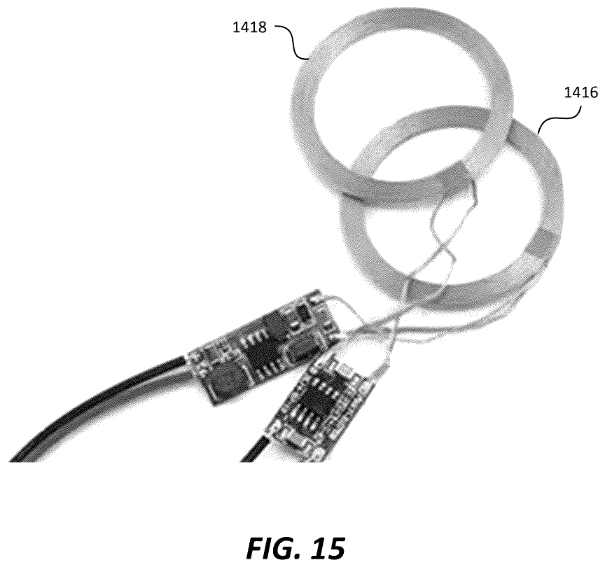

FIG. 15 illustrates a perspective view of example transmitter and receiver coils 1416, 1418 that may be implemented in the wireless power transfer circuits of FIGS. 14A and 14B, in accordance with the present teachings. In some examples, the transmitter and receiver coils 1416, 1418 are manufactured with and/or sold with the puck 1400 but separately from the rotary joint 110. In some examples, the transmitter and receiver coils 1416, 1418 are manufactured and sold separately from both the puck 1400 and the rotary joint 110. In such examples, the transmitter and receiver coils 1416, 1418 can be installed on the puck 1400 and/or in the rotary joint 110 after the puck 1400 has already been installed in the rotary joint 110. In some examples, the transmitter and receiver coils 1416, 1418 are manufactured with and/or sold with the rotary joint 110 but separately from the puck 1400. In such examples, the puck 1400 can be connected to the transmitter and/or receiver coils 1416, 1418 during installation of the puck 1400 in the rotary joint 110.

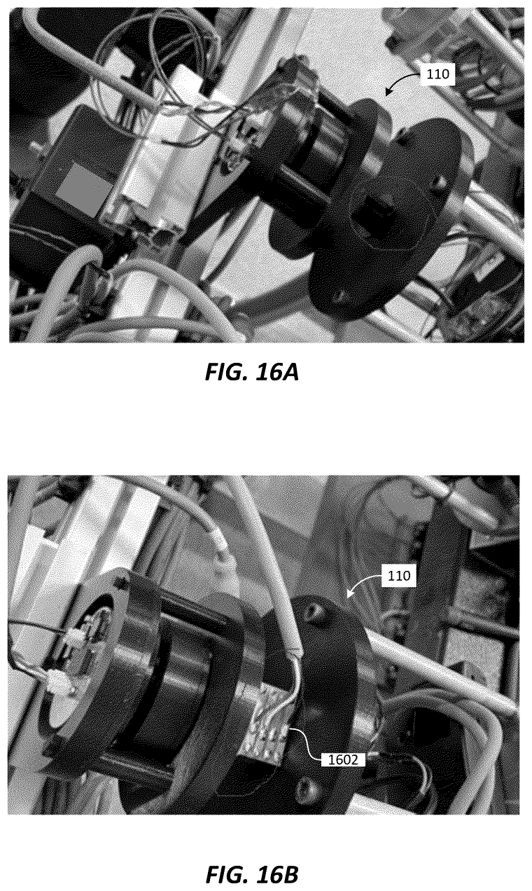

FIG. 16A illustrates an example rotary joint 110 in which an alignment module that includes a wireless power transfer circuit (e.g., puck 1400) has been installed, in accordance with the present teachings. FIG. 16B illustrates an example rotary joint 110 in which an alignment module that does not include a wireless power transfer circuit (e.g., puck 500 or puck 1000) has been installed, in accordance with the present teachings. When compared to the rotary joint 110 of FIG. 16B, the rotary joint 110 of FIG. 16A does not include a separate power supply module 1602 comprising brushes and slip ring contacts for providing power to the dynamic wireless module. Rather, the separate power supply module 1602 can be removed from the rotary joint of FIG. 16A because power can be wirelessly provided to the dynamic wireless module of the alignment module.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A rotary joint, comprising:
a stator;
a rotor configured to rotate relative to the stator about a rotation axis; and
an alignment module mounted to the rotor, the alignment module including a housing having a first wireless module with a first antenna; and
a rotational element coupled to the first rotor and configured to rotate about the rotation axis relative to the housing, the rotational element having a second wireless module with a second antenna;
wherein the first and second antennae are aligned along the rotation axis and adapted to wirelessly communicate with each other.

2. The rotary joint according to claim 1, wherein the housing further having a support member configured to engage a surface of the stator or a component disposed within the stator.

3. The rotary joint according to claim 1, wherein the housing further includes a flange having a hole formed therein to receive a stator pin coupled to the stator.

4. An alignment module for wireless communication in a rotary joint, comprising:
a housing including a first wireless module with a first antenna; and
a rotational element configured to be coupled to a rotor of the rotary joint and rotate relative to the housing about a rotation axis, the rotational element having a second wireless module with a second antenna;
wherein the first and second antennae are aligned along the rotation axis and adapted to wirelessly communicate with each other.

5. The alignment module according to claim 4, wherein the second antenna is configured to rotate relative to the first wireless module.

6. The alignment module according to claim 4, wherein the housing further includes a support member configured to engage a surface of the rotary joint or a stationary component disposed within the rotary joint.

7. The alignment module according to claim 4, wherein the housing further includes a flange having a hole formed therein to receive a stator pin coupled to the rotary joint.

8. The alignment module according to claim 7, further comprising:
a transmitter coil adapted to wirelessly transmit power; and
a receiver coil adapted to receive the power wirelessly transmitted by the transmitter coil and to provide the received power to the second wireless module.

9. The alignment module according to claim 8, wherein the second wireless module and the receiver coil are adapted to rotate with the rotational element.

10. The alignment module according to claim 4, further comprising:
a transmitter coil adapted to wirelessly transmit power; and
a receiver coil adapted to receive the power wirelessly transmitted by the transmitter coil and to provide the received power to the second wireless module.

11. The alignment module according to claim 10, wherein the second wireless module and the receiver coil are adapted to rotate with the rotational element.

12. The alignment module according to claim 4, further comprising a first coil adapted to power the second wireless module with power wirelessly transmitted by a second coil;
wherein the second wireless module and the first coil are adapted to rotate with the rotational element.

13. A rotary joint, comprising:
a stator;
a rotor configured to rotate relative to the stator about a rotation axis; and
an alignment module according to claim 4 mounted to the rotor.

14. A wireless power transfer circuit for a rotary joint, comprising:
a power supply;
a transmitter coil adapted to receive power from the power supply;
a driving circuit adapted to control the transmitter coil to wirelessly transmit the power; and
a receiver coil adapted to receive the power wirelessly transmitted by the transmitter coil and to provide the received power to a wireless communication module.
